(19) United States
(12) Patent Application Publication
(10) Pub. No.: US 2025/0364702 A1
(43) Pub. Date: Nov. 27, 2025

(54) SECONDARY BATTERY

(71) Applicant: Samsung SDI Co., Ltd., Yongin-si (KR)

(72) Inventors: Yoon Jong CHO, Yongin-si (KR); Hyun Ki JUNG, Yongin-si (KR); Woo Hyuk CHOI, Yongin-si (KR); Myung Seob KIM, Yongin-si (KR); Gwan Hyeon YU, Yongin-si (KR); Yoon Sun YOO, Yongin-si (KR); Woo Tae JUN, Yongin-si (KR); Eun Ji KIM, Yongin-si (KR); Gun Gue PARK, Yongin-si (KR); Sung Gwi KO, Yongin-si (KR)

(21) Appl. No.: 19/012,680

(22) Filed: Jan. 7, 2025

(30) Foreign Application Priority Data
May 27, 2024 (KR) 10-2024-0068335

(51) Int. Cl. H01M 50/533; H01M 10/04; H01M 50/107; H01M 50/152; H01M 50/167; H01M 50/186; H01M 50/536; H01M 50/548; H01M 50/583

(52) U.S. Cl. CPC H01M 50/533; H01M 10/0431; H01M 50/107; H01M 50/152; H01M 50/167; H01M 50/186; H01M 50/536; H01M 50/548; H01M 50/583; H01M 2200/103

(57) ABSTRACT

A secondary battery includes an electrode assembly having a first electrode plate, a separator, and a second electrode plate; a case accommodating the electrode assembly is and the lower end of the case is open; terminals penetrating the upper surface of the case; a first current collector plate between the upper surface of the electrode assembly and the case and electrically connecting the first electrode plate and the terminals; and a cap plate sealing the lower end of the case. In the first current collector plate, the surface roughness of the lower surface of the first current collector plate is greater than that of the upper surface.

### CROSS-REFERENCE TO RELATED APPLICATION

The present application claims priority to and the benefit of Korean Patent Application No. 10-2024-0068335, filed on May 27, 2024, in the Korean Intellectual Property Office, the disclosure of which is incorporated by reference herein in its entirety.

### BACKGROUND

### 1. Field

The present disclosure relates to a secondary battery.

### 2. Description of the Related Art

Unlike primary batteries that are not designed to be recharged, secondary (or rechargeable) batteries are batteries that are designed to be discharged and recharged. Low-capacity secondary batteries are used in portable, small electronic devices, such as smart phones, feature phones, notebook computers, digital cameras, and camcorders, whereas large-capacity secondary batteries are widely used as power sources for driving motors in hybrid vehicles and electric vehicles and for storing power (e.g., home and/or utility scale power storage). A secondary battery generally includes an electrode assembly including a positive electrode and a negative electrode, a case accommodating the electrode assembly, and electrode terminals connected to the electrode assembly.

The above information disclosed in this Background section is for enhancement of understanding of the background of the present disclosure, and therefore, it may contain information that does not constitute related (or prior) art.

### SUMMARY

The present disclosure relates to various embodiments of a secondary battery in which the upper and lower surfaces of an electrode assembly have surface roughness, and by increasing the roughness of the surface of a current collector plate in contact with the upper and lower surfaces of the electrode assembly, the contact resistance can be reduced.

In addition, the present disclosure relates to various embodiments of a secondary battery in which to increase the capacity of the secondary battery, the thickness of a current collector plate is reduced, and thus increased resistance due to a reduction in the horizontal electron flow path can be ameliorated or mitigated (or at least partially offset) by reducing the contact resistance with an electrode assembly by increasing the surface roughness. That is, the increased resistance due to reducing the thickness of the current collector plate can be offset (or at least partially offset) by increasing the surface roughness of the current collector plate and thereby reducing the contact resistance.

These and other aspects and features of the present disclosure will be described in or will be apparent from the following description of embodiments of the present disclosure.

A secondary battery according to one embodiment of the present disclosure includes an electrode assembly having a first electrode plate, a separator, and a second electrode plate; a case accommodating the electrode assembly and having a lower end that is open; terminals penetrating the upper surface of the case; a first current collector plate between the upper surface of the electrode assembly and the case and electrically connecting the first electrode plate and the terminals; and a cap plate sealing the lower end of the case. In the first current collector plate, the surface roughness of the lower surface of the first current collector plate is greater than that of the upper surface.

The first electrode plate may further include first electrode tabs that protrude upwardly from the upper surface of the electrode assembly and that are bent and compacted in a winding axis direction of the electrode assembly. The second electrode plate may protrude downward from the lower surface of the electrode assembly and may further include second electrode tabs that are bent and compacted in the winding axis direction of the electrode assembly. The electrode assembly may have first electrode tabs exposed on the upper surface and second electrode tabs exposed on the lower surface.

The first current collector plate may be a flat circular plate that is welded to the upper surface of the electrode assembly.

The first current collector plate may include a terminal connection part that is in contact with and electrically connected to the lower surface of the terminal, and an electrode plate connection part that is in contact with and electrically connected to the first electrode tab exposed to the upper surface of the electrode assembly and is on an outer side of the terminal connection part.

The first current collector plate may further include a fuse part between the terminal connection part and the electrode plate connection part.

The fuse part may include: a fuse hole extending along a portion of an outer periphery of the terminal connection part; and an electrode plate connector connecting the terminal connection part and the electrode plate connection part.

On the lower surface of the first current collector plate, the surface roughness of the electrode plate connection part may be greater than or equal to the surface roughnesses of other regions of the first current collector part.

The secondary battery may further include a second current collector plate that is shaped of a flat circular plate and is in contact with and electrically connected to the second electrode tab exposed to the lower surface of the electrode assembly.

In the second current collector plate, the surface roughness of the upper surface may be greater than the surface roughness of the lower surface.

The second current collector plate may further include: a flat circular plate that is in contact with the lower surface of the electrode assembly; and an extension portion that extends downward from the edge of the flat portion.

On the upper surface of the second current collector plate, the surface roughness of the flat portion may be greater than the surface roughness of the extension portion.

The case may include: a beading part recessed into an interior of the case on the upper portion of the cap plate; and a crimping part in which the lower portion of the case is bent inwardly on the lower portion of the cap plate to secure the cap plate.

The secondary battery may further include a cap gasket between the cap plate and the beading part, and between the cap plate and the crimping part. The cap plate may be non-polar.

The extension portion of the second current collector plate may be between the cap gasket and the beading part.

In the electrode assembly, the surface roughness of the lower surface may be greater than the surface roughness of the upper surface.

The surface roughness of the upper surface of the second current collector plate may be greater than the surface roughness of the lower surface of the first current collector plate.

The first electrode tabs may be arranged along the winding direction so as to be spaced apart from each other in a first uncoated portion of the first electrode plate on which no electrode active material is provided.

The first electrode tabs may not be provided at the winding leading end and the winding terminating end of the first electrode plate.

The fuse part may include fuse holes, and the fuse holes may be substantially concentric with respect to the center of the first current collector plate.

The fuse part may further include protrusion holes at both ends of the fuse holes, and the protrusion holes may protrude in a direction facing each other.

According to the present disclosure, a secondary battery may be provided in which the upper and lower surfaces of an electrode assembly have surface roughness, and thus, by increasing the roughness of the surface of a current collector plate in contact with the upper and lower surfaces of the electrode assembly, the contact resistance can be reduced.

In addition, according to the present disclosure, a secondary battery may be provided in which to increase the capacity of the secondary battery, the thickness of a current collector plate is reduced, and thus the increased resistance due to a reduction in the horizontal electron flow path can be ameliorated or mitigated (or at least partially offset) by reducing the contact resistance with an electrode assembly by increasing the surface roughness.

However, the aspects and features of the present disclosure are not limited to those described above, and other aspects and features not expressly described herein will be clearly understood by a person skilled in the art from the description of example embodiments of described below.

### BRIEF DESCRIPTION OF DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 is a is a perspective view showing a secondary battery according to an embodiment of the present disclosure.

FIG. 2 is a cross-sectional view of the secondary battery shown in FIG. 1.

FIG. 3 is a perspective view showing an electrode assembly in the secondary battery of FIG. 1.

FIG. 4 is a cross-sectional view of the electrode assembly of FIG. 3.

FIG. 5 is an exploded perspective view showing the electrode assembly and a current collector plate in the secondary battery of FIG. 1.

FIG. 6 is a cross-sectional view of FIG. 5.

FIG. 7 is an enlarged view of portion A of FIG. 2.

FIG. 8 is a plan view showing four regions randomly selected from the upper and lower surfaces of the electrode assembly in FIG. 5.

FIGS. 9A to 9C are bottom views showing a roughened region on the lower surface of a first current collector plate in the secondary battery of FIG. 1.

FIGS. 10 to 13 are plan views showing various embodiments of the first current collector plate in the secondary battery shown in FIGS. 1 to 6.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

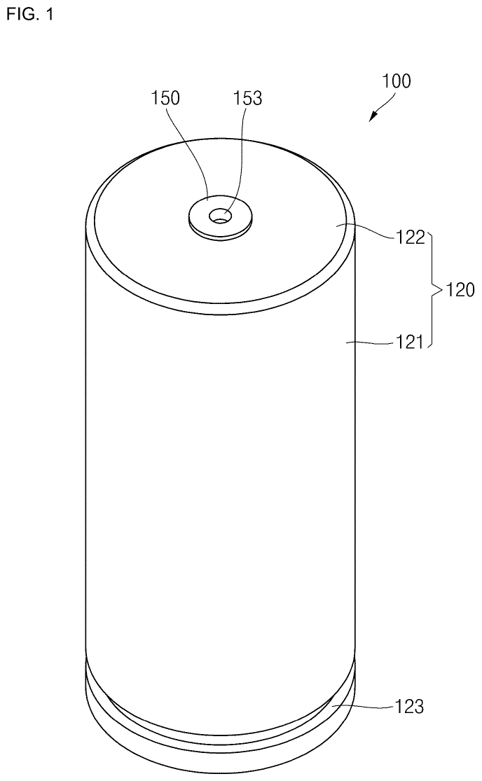

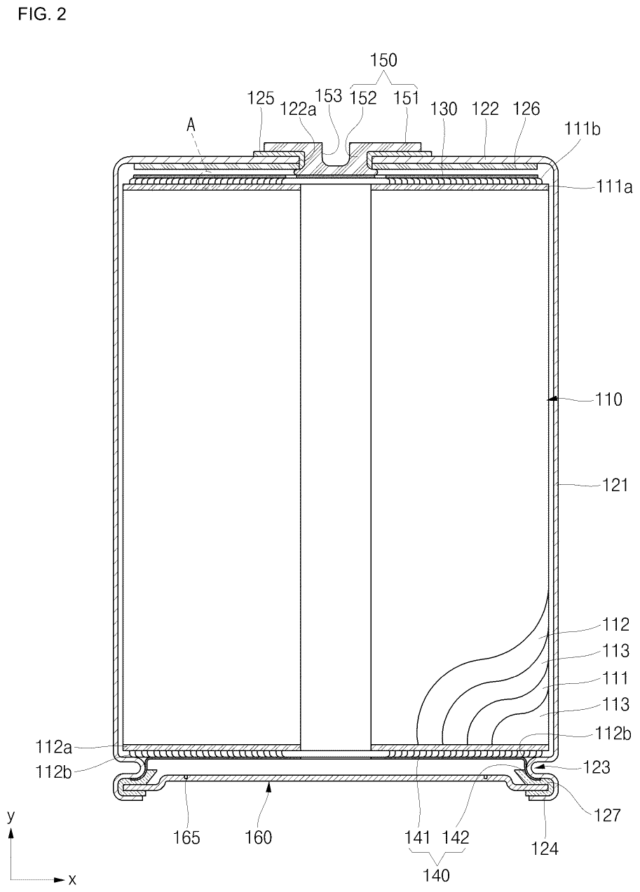

FIG. 1 is a is a perspective view showing a secondary battery according to the present disclosure, and FIG. 2 is a cross-sectional view of the secondary battery shown in FIG. 1.

As shown in FIGS. 1 and 2, the secondary battery 100 may include an electrode assembly 110, a case 120 that accommodates the electrode assembly 110 and an electrolyte therein, a terminal 150 coupled to a terminal hole 122a provided at one end (e.g., an upper end) of the case 120, and a cap plate 160 that seals the other end (e.g., a lower end) of the case 110. In some embodiments, the secondary battery 100 may have a terminal hole provided on the cap plate 160 such that the terminal 150 may be coupled on or to the cap plate 160.

The secondary battery 100 may further include a first current collector plate 130 that electrically connects a first electrode 111 of the electrode assembly 110 to the terminal 150, and a second current collector plate 140 that electrically connects a second electrode 112 of the electrode assembly 110 to the case 120.

The electrode assembly 110 may include a separator 113, and the first electrode plate 111 and the second electrode plate 112 positioned with the separator 113 therebetween may be wound in a jelly-roll configuration.

The first electrode plate 111 includes a first substrate and a first active material layer on the first substrate. In the first substrate, a first electrode tab 111b may extend outward from an uncoated portion 111a of the first electrode where the first active material layer is not positioned or provided, and the first electrode tab 111b may be electrically connected to the terminal 150 through the first current collector plate 130.

The second electrode plate 112 includes a second substrate and a second active material layer on the second substrate. In the second substrate, a second electrode tab 112b may extend outward from a second electrode uncoated portion 112a where the second active material layer is not positioned or located, and the second electrode tab 112b may be electrically connected to the case 120 through the second current collector plate 140.

The first electrode tab 111b and the second electrode tab 112b may be positioned or extend in opposite directions in the electrode assembly 110. The first electrode plate 111 may function as a positive electrode. In such an embodiment, the first substrate may be composed of, for example, aluminum foil, and the first active material layer may include, for example, a transition metal oxide. The second electrode plate 112 may function as a negative electrode. In such an embodiment, the second substrate may be composed of, for example, a copper foil or a nickel foil, and the second active material layer may include, for example, graphite.

The separator 113 is configured to prevent a short circuit between the first electrode 111 and the second electrode 112 and to allow the movement of lithium ions. The separator 113 may be composed of, for example, a polyethylene film, a polypropylene film, a polyethylene-polypropylene film, etc.

The case 120 accommodates the electrode assembly 110 and the electrolyte. Together with the terminal 150 and the cap plate 160, the case 120 forms the outer shape of the secondary battery 100. The case 120 may include a body portion 121 having a generally cylindrical shape, and a top portion 122 connected to one side (the upper side) of the body portion 121. A beading part 123 that is deformed toward the inside (e.g., deformed radially inward) may be on the body portion 121, and a crimping part 124 that is bent toward the inside (e.g., bent radially inward) may be positioned on an end of the open side of the body portion 121. The top portion 122 may be provided with a terminal hole 122a penetrating the center (or substantially the center) thereof. The top portion 122 may be coupled by having the terminal 150 inserted into the terminal hole 122a. A terminal gasket 125 for sealing and electrical insulation may be between the terminal hole 122a and the terminal 150.

The beading part 123 is configured to prevent (or at least mitigate) the electrode assembly 110 from moving inside the case 120 and to facilitate secure seating of the cap gasket 127 and the cap plate 160. The crimping part 124 is configured to firmly fix the cap plate 160 by pressing the edge of the cap plate 160 through the cap gasket 127. The case 123 may be made of, for example, nickel-plated iron.

The first current collector plate 130 may have one surface in contact with and coupled to the first electrode tab 111b of the electrode assembly 110 and another surface in contact with and coupled to the terminal 150. The first current collector plate 130 may be welded to the first electrode tab 111b of the electrode assembly 110 to form an electrical connection. The first current collector plate 130 may be welded and electrically connected to the first electrode tab 111b in a state in which the other surface thereof is in contact with the terminal 150.

The second current collector plate 140 may have a center portion 141 in contact with and coupled to the second electrode tab 112b of the electrode assembly 110 and an edge portion 142 in contact with and coupled to the body portion 121 of the case 120. In the second current collector plate 140, the center portion 141 may be welded to the second electrode tab 112b of the electrode assembly 110 to form an electrical connection. The second current collector plate 140 may be welded and electrically connected to the second electrode tab 112b in a state in which the edge portion 142 is in contact with the beading part 123 of the case 120.

The terminal 150 may include a head 151 on the outside of the case 120, and a fastening part 152 extending inwardly (e.g., downward) from the center of the head 151 toward the inside of the case 120. The terminal 150 may be fixed and sealed by pressing the top portion 122 of the case 120 from the inside through the terminal gasket 125 by coupling the fastening part 152 together with the terminal gasket 125 in the terminal hole 122a. The terminal 150 may include a terminal groove 153 extending from the center of the head 151 toward the fastening part 152. The terminal 150 may be welded externally to the first current collector plate 130 through the terminal groove 153. The terminal 150 may be electrically connected to the first electrode 111 of the electrode assembly 110 through the first current collector plate 130. The terminal 150 and the case 120 may have different polarities.

The cap plate 160 may be fixed to the inside of the crimping part 124 through the cap gasket 127 to seal the case 120. The cap plate 160 may include a safety vent 165 that is thinner than other regions of the cap plate 160 due to a notch. In response to gas being generated due to overcharging or an abnormal operation of the secondary battery 100, the safety vent 165 in the cap plate 160 may be cut along the notch. The cut safety vent 165 may therefore prevent explosion of the secondary battery 100 by releasing the gas to the outside.

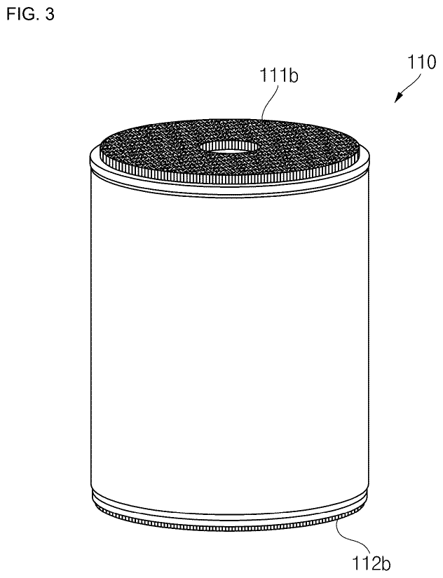

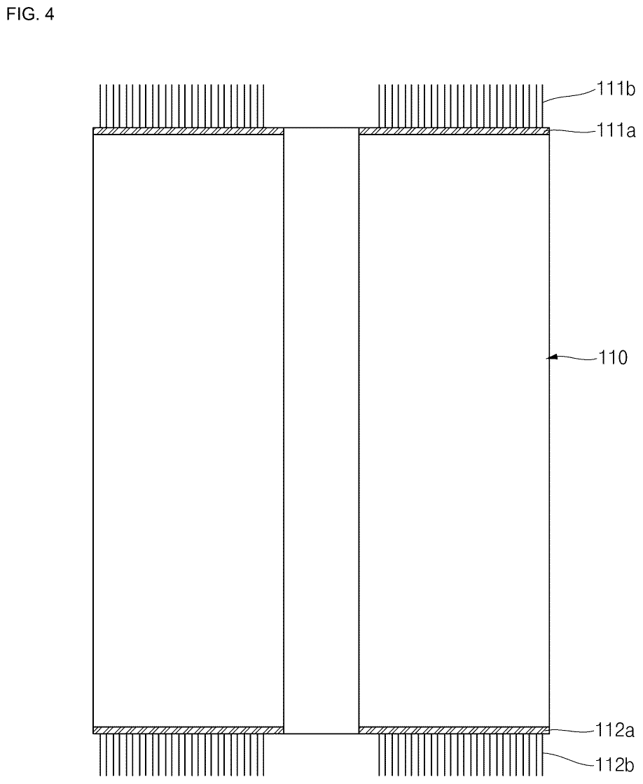

FIG. 3 is a perspective view showing an electrode assembly in the secondary battery of FIG. 1, and FIG. 4 is a cross-sectional view of the electrode assembly of FIG. 3. In FIGS. 3 and 4, the electrode assembly 110 is shown in a state before bending the first electrode tab 111b that protrudes upward and the second electrode tab 112b that protrudes downward.

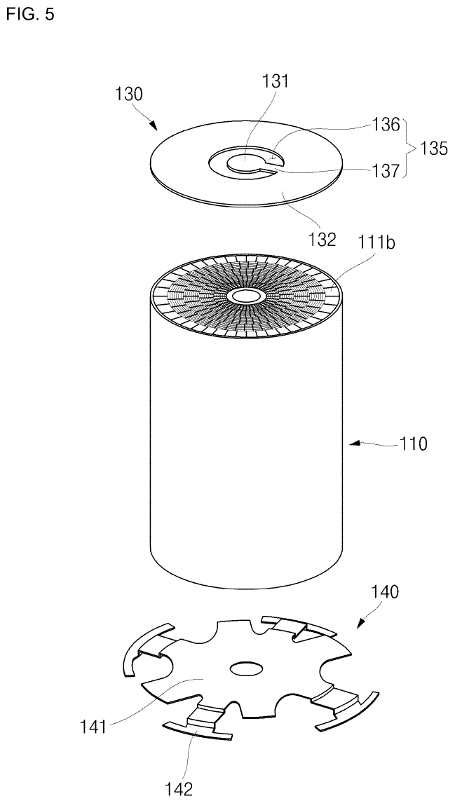

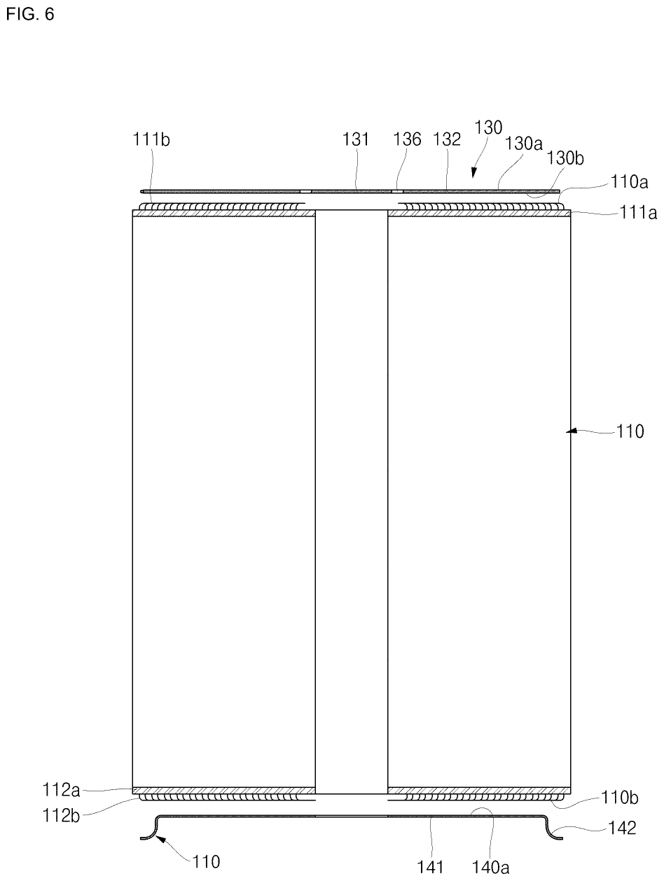

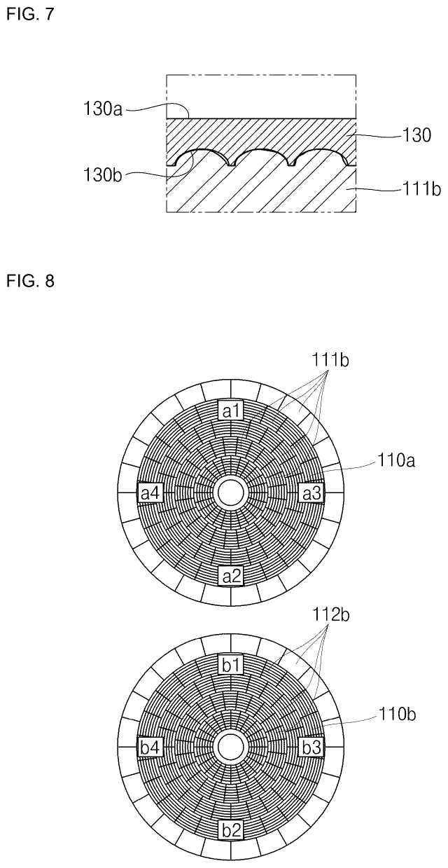

FIG. 5 is a perspective view showing the electrode assembly 110 shown in FIG. 3 after the first electrode tab 111b and the second electrode tab 112b are bent toward a core. In addition, FIG. 5 is an exploded perspective view of the secondary battery of FIG. 1, in which the electrode assembly 110, the first current collector plate 130, and the second current collector plate 140 are exploded. FIG. 6 is a cross-sectional view of FIG. 5. FIG. 7 is an enlarged view of portion A of FIG. 2.

Hereinafter, with reference to FIGS. 3 to 7, the configurations and relationship of the electrode assembly 110, the first current collector plate 130, and the second current collector plate 140 will be described.

The first electrode plate 111 may include on an upper portion thereof a first electrode uncoated portion 111a that is not coated with a first electrode active material. The first electrode uncoated portion 111a may protrude upward from the electrode assembly 110. In addition, the first electrode uncoated portion 111a may include a plurality of first electrode tabs 111b. The plurality of first electrode tabs 111b may be on the upper portion of the first electrode uncoated portion 111a and may be spaced apart from each other in one direction before winding. The plurality of first electrode tabs 111b may not be provided on the winding leading end and/or the winding terminating end. The plurality of first electrode tabs 111b may be formed on the first electrode uncoated portion 111a by laser notching, ultrasonic cutting, or punching. The first electrode tabs 111b may protrude further upward from the electrode assembly 110 than the second electrode plate 112 and the separator 113.

The second electrode plate 112 may include on a lower end thereof a second electrode uncoated portion 112a that is not coated with a second electrode active material. In addition, the second electrode uncoated portion 112a may include a plurality of second electrode tabs 112b. The plurality of second electrode tabs 112b may be at the lower end of the second electrode uncoated portion 112a and may be spaced apart from each other in one direction before winding. The plurality of second electrode tabs 112b may not be provided on the winding leading end and/or the winding terminating end. The plurality of second electrode tabs 112b may be formed on the second electrode uncoated portion 112a by laser notching, ultrasonic cutting, or punching. The second electrode tabs 112b may protrude further downward from the electrode assembly 110 than the first electrode plate 111 and the separator 113.

In the electrode assembly 110, the first electrode tab 111b may protrude upward, and the second electrode tab 112b may protrude downward. The first electrode tab 111b and the second electrode tab 112b may be bent toward the core or the center of the electrode assembly 110. That is, the plurality of first electrode tabs 111b and the plurality of second electrode tabs 112b may be bent and compacted from a winding leading end region toward the core or center. The first electrode tabs 111b and the second electrode tabs 112b may not be provided in some regions of the winding leading end so as not to cover a core hole of the electrode assembly 110. The electrode assembly 110 may have surface roughness due to the occurrence of a step on each of an upper surface 110a and a lower surface 110b due to a height difference caused by the bending and compacting of the first electrode tabs 111b and the second electrode tabs 112b.

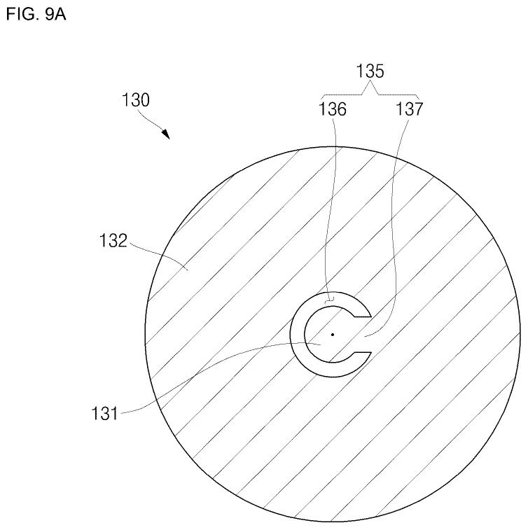

The first electrode tabs 111b may be on the upper surface 110a of the electrode assembly 110, and the second electrode tabs 112b may be on the lower surface 110b of the electrode assembly 110. FIG. 8 shows four regions randomly selected from the upper surface 110a and the lower surface 110b of the electrode assembly 110. Here, the randomly selected four regions are shown as being symmetrical to each other with respect to the core, but any regions that have the same area may be selected. The four randomly selected regions may be regions in contact with the first current collector plate 130 and the second current collector plate 140. In addition, the four randomly selected regions may be regions that are not welded with the first current collector plate 130 and the second current collector plate 140.

Surface roughness data, including a maximum height (Sz) and an average height (Sa) measured in a first region (a1), a second region (a2), a third region (a3), and a fourth region (a4) of the upper surface 110a of the electrode assembly 110, and a maximum height (Sz) and an average height (Sa) in a first region (b1), a second region (b2), a third region (b3), and a fourth region (b4) of the lower surface 110b of the electrode assembly 110, are shown in Table 1 below. As used herein, the maximum height (Sz) may the height from the lowest point to the highest point (peak) within the area of each region, and the average height (Sa) may be the average roughness within the area of each region.

Surface roughness data for the upper surface 110a and the lower surface 110b of the electrode assembly 110 were measured for a total of three electrode assemblies 110, and Table 1 shows the experimental results for a first electrode assembly, Table 2 shows the experimental results for a second electrode assembly, and Table 3 shows the experimental results for a third electrode assembly. Here, the first electrode assembly, the second electrode assembly, and the third electrode assembly are electrode assemblies having the same structure and manufactured through the same process(es). Hereinafter, the unit is a micrometer (μm).

TABLE 1

| Upper surface (110a) | Sa | Sz | Lower surface (110b) | Sa | Sz |
|---|---|---|---|---|---|
| First region (a1) | 14.895 | 177.730 | First region (b1) | 39.596 | 191.190 |
| Second region (a2) | 14.140 | 127.890 | Second region (b2) | 20.413 | 154.590 |
| Third region (a3) | 12.433 | 123.550 | Third region (b3) | 35.470 | 164.840 |
| Fourth region (a4) | 14.658 | 281.420 | Fourth region (b4) | 38.031 | 217.630 |
| Average | 14.031 | 177.648 | Average | 33.373 | 182.063 |
| Standard deviation | 0.963 | 63.583 | Standard deviation | 7.627 | 24.493 |

TABLE 2

| Upper surface (110a) | Sa | Sz | Lower surface (110b) | Sa | Sz |
|---|---|---|---|---|---|
| First region (a1) | 13.076 | 128.230 | First region (b1) | 21.683 | 156.060 |
| Second region (a2) | 15.564 | 133.240 | Second region (b2) | 36.667 | 231.280 |
| Third region (a3) | 16.712 | 158.220 | Third region (b3) | 18.696 | 147.390 |
| Fourth region (a4) | 36.595 | 502.330 | Fourth region (b4) | 36.895 | 182.140 |
| Average | 19.971 | 230.505 | Average | 24.485 | 179.218 |
| Standard deviation | 8.509 | 157.349 | Standard deviation | 8.363 | 32.666 |

TABLE 3

| Upper surface (110a) | Sa | Sz | Lower surface (110b) | Sa | Sz |
|---|---|---|---|---|---|
| First region (a1) | 15.553 | 165.060 | First region (b1) | 41.026 | 214.340 |
| Second region (a2) | 18.525 | 250.980 | Second region (b2) | 37.204 | 211.560 |
| Third region (a3) | 13.827 | 141.380 | Third region (b3) | 29.711 | 156.110 |
| Fourth region (a4) | 24.906 | 520.360 | Fourth region (b4) | 38.648 | 236.500 |
| Average | 18.203 | 269.445 | Average | 36.647 | 204.628 |
| Standard deviation | 4.219 | 150.496 | Standard deviation | 4.231 | 29.632 |

In Tables 1 to 3, referring to the surface roughness data for the upper surface 110a of the electrode assembly 110, the average height (Sa) measured for each region (a1 to a4) may be approximately 12 μm to approximately 36 μm, and the maximum height (Sz) may be approximately 123 μm to approximately 520 μm. In addition, referring to the surface roughness data for the lower surface 110b of the electrode assembly 110, the average height (Sa) measured for each region may be approximately 18 μm to approximately 41 μm, and the maximum height (Sz) may be approximately 147 μm to approximately 236 μm.

Referring to the surface roughness data of the electrode assembly 110 in Tables 1 to 3, the upper surface 110a and the lower surface 110b of the electrode assembly 110 may have a surface roughness due to uneven steps caused by bending and compaction of the first electrode tab 111b and the second electrode tab 112b, respectively. In addition, the electrode assembly 110 may have a greater surface roughness at the lower surface 110b than that at the upper surface 110a.

When the flat first current collector plate 130 comes into contact with the upper surface 110a of the electrode assembly 110 having such surface roughness, resistance may increase due to a low contact area. To prevent (or at least mitigate) this, the lower surface 130b of the first current collector plate 130 that comes into contact with the upper surface 110a of the electrode assembly 110 may have surface roughness, thereby reducing the contact resistance between the first current collector plate 130 and the first electrode tab 111b of the electrode assembly 110.

In addition, when the flat second current collector plate 140 comes into contact with the lower surface 110b of the electrode assembly 110 having surface roughness, resistance may increase due to a low contact area. To prevent (or at least mitigate) this, the upper surface 140a of the second current collector plate 140 that comes into contact with the lower surface 110b of the electrode assembly 110 may have surface roughness, thereby reducing the contact resistance between the second current collector plate 140 and the second current collector plate 140 of the electrode assembly 110.

In one or more embodiments, the first current collector plate 130 may be a circular metal plate having a shape corresponding (or substantially corresponding) to the upper surface 110a of the electrode assembly 110. The planar size of the first current collector plate 130 may be equal (or substantially equal) to or smaller than the size of the upper surface 110a of the electrode assembly 110. The first current collector plate 130 may be fixed and electrically connected to the first electrode tab 111b of the electrode assembly 110 by welding in a state in which the lower surface 130b of the first current collector plate 130 is in contact with the upper surface 110a of the electrode assembly 110. The first current collector plate 130 may be fixed and electrically connected to the terminal 150 by welding in a state in which the upper surface 130a is in contact with the lower surface of the terminal 150. The first current collector plate 130 is configured to serve as a passage for current flow between the first electrode plate 111 of the electrode assembly 110 and the terminal 150. The first current collector plate 130 may be welded to the electrode assembly 110, accommodated in the case 120, and welded to the terminal 150.

The lower surface 130b of the first current collector plate 130 may have a greater surface roughness of the upper surface 130a of the first current collector plate 130. Here, a greater surface roughness may mean that an average height and/or a maximum height in a plane and/or a unidirectional line is greater. The first current collector plate 130 may increase the surface roughness of the lower surface 130b through roughness treatment. The roughness treatment may be, for example, blasting, polishing, or etching.

In the first current collector plate 130, the surface roughness of the lower surface 130b may have a maximum height (Ry) of approximately 7 μm to approximately 9 μm and an average height (Ra) of approximately 0.6 μm to approximately 0.9 μm. When the average height of the roughness of the lower surface 130b of the first current collector plate 130 is less than 0.6 μm, a contact area between the first current collector plate 130 and the electrode assembly 110 may be reduced, thereby increasing resistance. When the average height of the roughness of the lower surface 130b of the first current collector plate 130 is greater than 0.9 μm or the maximum height (Ry) thereof is greater than 9 μm, an electron movement path may be reduced in a horizontal direction (in a plane direction) of the first current collector plate 130, thereby increasing resistance. The surface roughness of the lower surface 130b of the first current collector plate 130 may be set and changed (varied) according to the surface roughness of the upper surface 110a of the electrode assembly 110.

The first current collector plate 130 may have a thickness such that after roughness treatment, the electron movement path may not be reduced (or substantially not reduced). In one or more embodiments, the first current collector plate 130 may have a thickness of approximately 0.2 mm to approximately 1.5 mm.

The first current collector plate 130 may include a terminal connection part 131, an electrode plate connection part 132, and a fuse part 135. The terminal connection part 131 is at the center (or substantially the center) of the first current collector plate 130 and may have an approximately circular shape. The lower surface of the fastening part 152 of the terminal 150 may be welded to the upper surface of the terminal connection part 131. The electrode plate connection part 132 is on the outer side of the terminal connection part 131 and may be in contact with and electrically connected to the first electrode tab 111b of the electrode assembly 110. In one or more embodiments, the first electrode tab 111b exposed to the upper surface 110a of the electrode assembly 110 may be welded to the lower surface of the electrode plate connection part 132.

The fuse part 135 may be between the terminal connection part 131 and the electrode plate connection part 132. The fuse part 135 may include a fuse hole 136 and an electrode plate connector 137. In response to a short circuit or overcurrent of the secondary battery 100 occurring, the electrode plate connector 137 may melt and be cut by the generated heat, and thus the fuse part 135 may block current flowing to the secondary battery 100.

In one or more embodiments, the fuse hole 136 has a roughly ‘C’ shape along a portion of the outer periphery of the terminal connection part 131, so that opposite ends of the fuse hole 136 may face each other. The fuse hole 136 may separate the terminal connection part 131 and the electrode plate connection part 132 from each other. That is, the terminal connection part 131 and the electrode plate connection part 132 may be separated from each other by the fuse hole 136.

The electrode plate connector 137 may connect the terminal connection part 131 and the electrode plate connection part 132. In response to a short circuit or overcurrent of the secondary battery 100 occurring, the electrode plate connector 137 is melted and cut by the generated heat to block the flow of electric current, thereby improving safety. The shape of the first current collector plate 130 may be changed into various forms having the terminal connection part 131, the electrode plate connection part 132, and the fuse part 135.

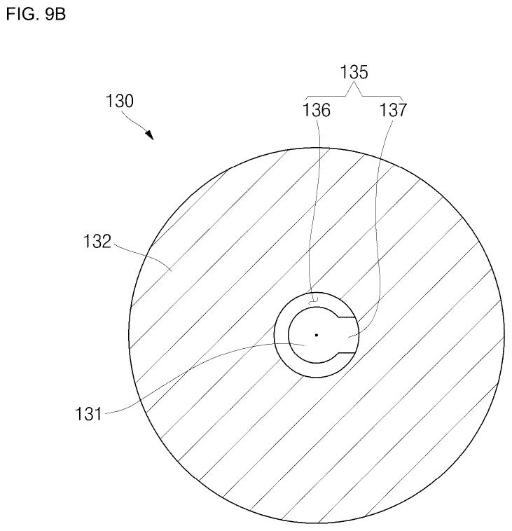

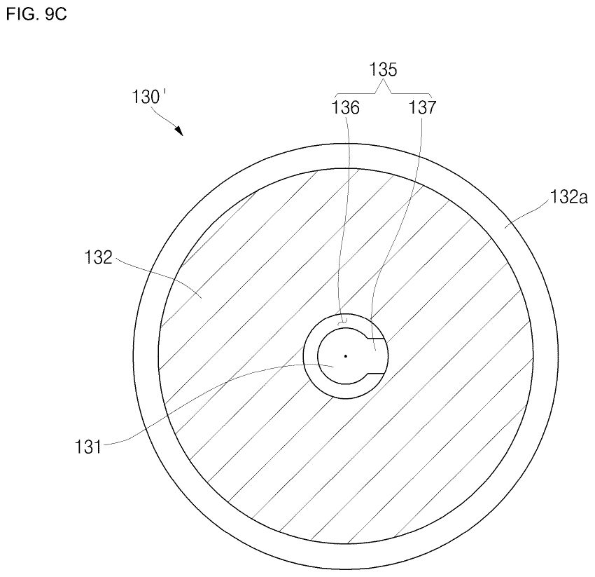

Referring to FIGS. 9A to 9C, bottom views of the first current collector plate 130 showing regions subjected to roughness treatment in the secondary battery 100 are shown. Each bottom view shows a region subjected to roughness treatment on the lower surface of the first current collector plate 130 as hatched.

In some embodiments, as shown in FIG. 9A, the first current collector plate 130 may include surface roughness treatment on the entire (or substantially the entire) region of the lower surface 130b. In some embodiments, as shown in FIG. 9B, the first current collector plate 130 may include surface roughness treatment only on the region of the lower surface 130b on which the electrode plate connection part 132 is positioned or located, and thus, the surface roughness of the lower surface of the electrode plate connection part 132 may be greater than that of other regions of the lower surface 130b.

In one or more embodiments, on the lower surface 130b of the first current collector plate 130 shown in FIG. 9A or FIG. 9B, the surface roughness of the region where the terminal connection part 131 is located or the region where the electrode plate connector 137 of the fuse part 135 is located may be smaller than or equal to the surface roughness of the electrode plate connection part 132.

In some embodiments, on the lower surface 130b of the first current collector plate 130, as shown in FIG. 9C, only the center region of the electrode plate connection part 132 may include the surface roughness treatment (i.e., an edge region 132a may not be subjected to roughness treatment). Here, the edge region 132a of the electrode plate connection part 132 may correspond to a region at the winding terminating end of the electrode assembly 110 where the first electrode tab 111b is not present. That is, in the electrode plate connection part 132, the surface roughness of the center region may be greater than or equal to the surface roughness of the edge region 132a.

The second current collector plate 140 may include a circular flat portion 141 corresponding to the lower surface 110b of the electrode assembly 110 and an extension portion 142 extending downward from an edge of the flat portion 141.

In the second current collector plate 140, the surface roughness of the upper surface 140a may be a greater than that of the lower surface 140b. Here, a greater surface roughness may mean that an average height and/or a maximum height in a plane and/or a unidirectional line is greater. The second current collector plate 140 may increase the surface roughness of the upper surface 140a through roughness treatment. The roughness treatment may be, for example, blasting, polishing, or etching.

In the second current collector plate 140, the surface roughness of the upper surface 140a may have a maximum height (Ry) of approximately 4.6 μm to approximately 5.6 μm and an average height (Ra) of approximately 0.39 μm to approximately 0.44 μm. Here, the average height (Ra) may be the average roughness based on the center line. When the average height of the roughness of the upper surface 140b of the second current collector plate 140 is less than 0.39 μm, the contact area between the second current collector plate 140 and the lower surface 110b of the electrode assembly 110 may decrease, thereby increasing resistance. When the average height of the roughness of the upper surface 140b of the second current collector plate 140 is greater than 0.44 μm or the maximum height (Ry) thereof is greater than 5.6 μm, an electron movement path may be reduced in a horizontal direction (in a plane direction) of the second current collector plate 140, thereby increasing resistance. The surface roughness of the upper surface 140b of the second current collector plate 140 may be set and changed (varied) according to the surface roughness of the lower surface 110b of the electrode assembly 110.

The second current collector plate 140 may have a thickness such that after roughness treatment, the electron movement path may not be reduced (or substantially not reduced). In one or more embodiments, the second current collector plate 140 may have a thickness of approximately 0.2 mm to approximately 1.5 mm.

In the second current collector plate 140, the surface roughness of the upper surface 140a may be greater than that of the lower surface 130b of the first current collector plate 130. Since the surface roughness of the lower surface 110b in the electrode assembly 110 is greater than that of the upper surface 110a, in order to increase the contact area with the lower surface 110b having a greater surface roughness, the surface roughness of the upper surface 110a of the second current collector plate 140 may be greater than the surface roughness of the lower surface 110b of the first current collector plate 130.

The flat portion 141 of the second current collector plate 140 may have an upper surface in contact with and electrically connected to the lower surface 110b of the electrode assembly 110. The upper surface of the flat portion 141 may be fixed and electrically connected to the second electrode tab 112b exposed to the lower portion of the electrode assembly 110 by welding in a state of being in contact with the lower surface 110b of the electrode assembly 110.

The extension portion 142 may extend downward from the edge of the flat portion 141. In one or more embodiments, a plurality of extension portions 142 may be spaced apart from each other along the edge of the flat portion 141. In addition, the extension portion 142 may be in contact with the inner surface of the beading part 123. That is, in one or more embodiments, the extension portion 142 may be rounded or bent along the beading part 123. Here, the inner surface may be the inner surface of the case 120. The extension portion 142 may have an end positioned between the beading part 123 and the cap gasket 127. The extension portion 142 may be in contact with and coupled to the beading part 123 of the case 120. In one or more embodiments, the extension portion 142 may be coupled by welding in a state of being in contact with the inner surface of the beading part 123 of the case 120. The second current collector plate 140 is configured to function a current flow path between the second electrode plate 112 of the electrode assembly 110 and the case 120. That is, the case 120 may be a negative electrode terminal. Additionally, in one or more embodiments, the second current collector plate 140 may be subjected to roughness treatment only in the region of the upper surface 140a where the flat portion 141 is located. Here, in the second current collector plate 140, the surface roughness of the upper surface of the flat portion 141 may be greater than that of the extension portion 142. Accordingly, on the upper surface 140a of the second current collector plate 140, the surface roughness of the flat portion 141 may be greater than or equal (or substantially equal) to that of the extension portion 142.

In the secondary battery 100, the electrode assembly 110 has surface roughness on the upper surface 110a and the lower surface 110b by bending and compacting the first electrode tab 111b and the second electrode tab 112b, and thus, the surface roughnesses of regions of the first current collector plate 130 and the second current collector plate 140 in contact with the electrode assembly 110 are also increased compared to other regions, thereby reducing the contact resistance between the electrode assembly 110 and the first current collector plate 130 and between the electrode assembly 110 and the second current collector plate 140.

In order to increase the capacity of the secondary battery 100, the thicknesses of the first current collector plate 130 and the second current collector plate 140 may be reduced such that an electron movement path (cross-sectional area) is reduced in the horizontal direction, and the resulting increase in resistance due to the reduced electron movement path (cross-sectional area) in the horizontal direction can be ameliorated or mitigated by reducing contact resistance with the electrode assembly 110 by increasing the surface roughness.

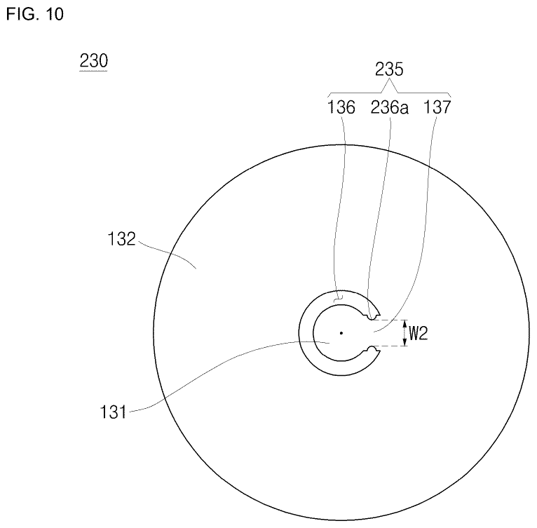

FIGS. 10 to 13 are plan views showing various examples of the first current collector plate in the secondary battery shown in FIGS. 1 to 6.

Referring to FIG. 10, a first current collector plate 230 may include a terminal connection part 131, an electrode plate connection part 132, and a fuse part 235. The fuse part 235 may include a fuse hole 136, an electrode plate connector 137, and a protrusion hole 236a. The protrusion hole 236a may be formed at one end and the other end of the fuse hole 136, respectively (i.e., at both ends). The protrusion holes 236a formed at opposite ends of the fuse hole 136 may protrude in a direction in which the protrusion holes 236a approach each other (i.e., the protrusion holes 236a may extend toward or face each other). The width of each of the protrusion holes 236a may be smaller than the width of the fuse hole 136. The protrusion holes 236a can improve the function of the fuse part 235 by reducing a width W2, i.e., the cross-sectional area, of the electrode plate connector 137, along which current flows.

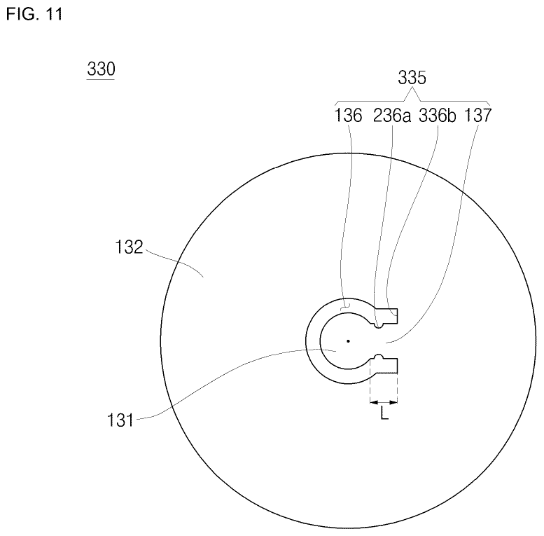

Referring to FIG. 11, a first current collector plate 330 may include a terminal connection part 131, an electrode plate connection part 132, and a fuse part 335. The fuse part 335 may include a fuse hole 136, an electrode plate connector 337, a protrusion hole 236a, and an extension hole 336b. The extension hole 336b may extend from opposite ends of the fuse hole 136 toward the outside of the first current collector plate 330 (e.g., the extension holes 336b may extend as much as the length of the electrode plate connector 337). The extension holes 336b formed at the opposite ends of the fuse hole 136 may be parallel (or substantially parallel) to each other. The extension holes 336b may increase the length (L) of the electrode plate connector 337, i.e., the length along which current flows, thereby improving the function of the fuse part 335.

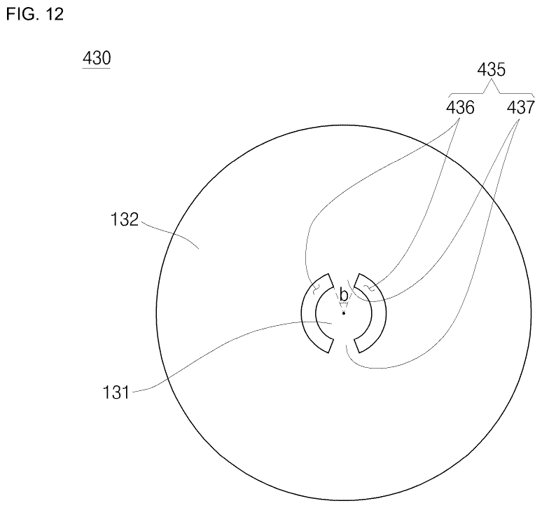

Referring to FIG. 12, a first current collector plate 430 may include a terminal connection part 131, an electrode plate connection part 132, and a fuse part 435. The fuse part 435 may include two fuse holes 436 spaced apart from each other, and two electrode plate connectors 437 positioned between the fuse holes 436. The two fuse holes 436 may concentric (or substantially concentric) with respect to the center of the first current collector plate 430 and may be symmetrical (or substantially symmetrical) to each other. An angle (b) formed by the electrode plate connector 437 with respect to the center of the first current collector plate 430 may be about (approximately) 30-50 degrees.

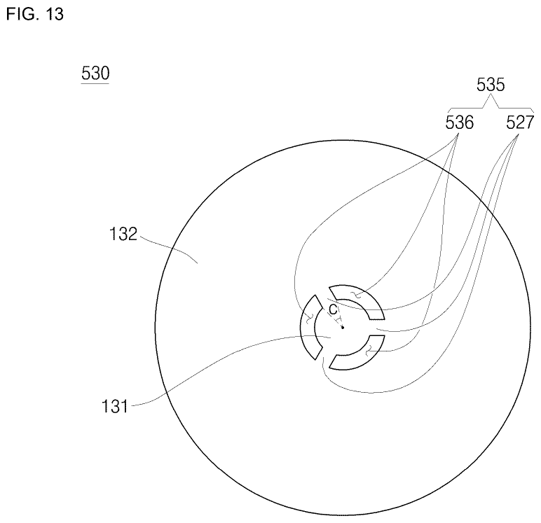

Referring to FIG. 13, a first current collector plate 530 may include a terminal connection part 131, an electrode plate connection part 132, and a fuse part 535. The fuse part 535 may include three fuse holes 536 spaced apart from each other and three electrode plate connectors 537 positioned between adjacent fuse holes 536. The three fuse holes 536 may be positioned concentrically (or substantially concentrically) with respect to the center of the first current collector plate 530 and may have the same size (or substantially the same size). An angle (c) formed by the electrode plate connector 537 with respect to the center of the first current collector plate 530 may be about (approximately) 8-15 degrees.

In one or more embodiments, the first current collector plate (230, 330, 430, 530) shown in FIGS. 10 to 13 may have the surface roughness treatment applied to the various regions shown in FIGS. 9A to 9C.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
an electrode assembly comprising a first electrode plate, a separator, and a second electrode plate;
a case accommodating the electrode assembly, a lower end of the case being open;
terminals penetrating an upper surface of the case;
a first current collector plate between the upper surface of the electrode assembly and the case and electrically connecting the first electrode plate and the terminals; and
a cap plate sealing the lower end of the case,
wherein in the first current collector plate, surface roughness of a lower surface of the first current collector plate is greater than that of an upper surface.

2. The secondary battery as claimed in claim 1, wherein the first electrode plate further comprises a plurality of first electrode tabs that protrude upwardly from the upper surface of the electrode assembly and are bent and compacted in a winding axis direction of the electrode assembly,
wherein the second electrode plate protrudes downward from the lower surface of the electrode assembly and further comprises a plurality of second electrode tabs that are bent and compacted in the winding axis direction of the electrode assembly, and
wherein the electrode assembly comprises a plurality of first electrode tabs exposed on the upper surface and a plurality of second electrode tabs exposed on the lower surface.

3. The secondary battery as claimed in claim 2, wherein the first current collector plate is a flat circular plate, and wherein the first current collector plate is welded to the upper surface of the electrode assembly.

4. The secondary battery as claimed in claim 3, wherein the first current collector plate comprises:
a terminal connection part in contact with and electrically connected to the lower surface of the terminals; and
an electrode plate connection part in contact with and electrically connected to a first electrode tab exposed to the upper surface of the electrode assembly and located on an outer side of the terminal connection part.

5. The secondary battery as claimed in claim 4, wherein the first current collector plate further comprises a fuse part between the terminal connection part and the electrode plate connection part.

6. The secondary battery as claimed in claim 5, wherein the fuse part comprises:
a fuse hole extending along a portion of an outer periphery of the terminal connection part; and
an electrode plate connector connecting the terminal connection part and the electrode plate connection part.

7. The secondary battery as claimed in claim 4, wherein the surface roughness of the lower surface of the electrode plate connection part is greater than or equal to surface roughnesses of other regions of the first current collector plate.

8. The secondary battery as claimed in claim 2, further comprising a second current collector plate comprising a flat circular plate corresponding to the lower surface of the electrode assembly and in contact with and electrically connected to a second electrode tab exposed to the lower surface of the electrode assembly.

9. The secondary battery as claimed in claim 8, wherein the surface roughness of the upper surface of the second current collector plate is greater than the surface roughness of the lower surface of the second current collector plate.

10. The secondary battery as claimed in claim 8, wherein the second current collector plate comprises:
a flat circular plate in contact with the lower surface of the electrode assembly; and
an extension portion extending downward from an edge of the flat circular plate.

11. The secondary battery as claimed in claim 10, wherein on the upper surface of the second current collector plate, the surface roughness of the flat circular plate is greater than the surface roughness of the extension portion.

12. The secondary battery as claimed in claim 10, wherein the case comprises:
a beading part recessed into an interior of the case and on an upper portion of the cap plate; and
a crimping part in which a lower portion of the case is bent inwardly on the lower portion of the cap plate to secure the cap plate.

13. The secondary battery as claimed in claim 12, further comprising a cap gasket between the cap plate and the beading part, and between the cap plate and the crimping part, wherein the cap plate is non-polar.

14. The secondary battery as claimed in claim 13, wherein the extension portion of the second current collector plate is between the cap gasket and the beading part.

15. The secondary battery as claimed in claim 9, wherein surface roughness of the lower surface of the electrode assembly is greater than surface roughness of the upper surface of the electrode assembly.

16. The secondary battery as claimed in claim 15, wherein the surface roughness of the upper surface of the second current collector plate is greater than the surface roughness of the lower surface of the first current collector plate.

17. The secondary battery as claimed in claim 2, wherein the plurality of first electrode tabs is arranged along a winding direction and spaced apart from each other in a first uncoated portion of the first electrode plate on which no electrode active material is provided.

18. The secondary battery as claimed in claim 2, wherein the plurality of first electrode tabs are not provided at a winding leading end and a winding terminating end of the first electrode plate.

19. The secondary battery as claimed in claim 6, wherein the fuse part comprises a plurality of fuse holes, and wherein the plurality of fuse holes is substantially concentric with respect to a center of the first current collector plate.

20. The secondary battery as claimed in claim 19, wherein the fuse part further comprises protrusion holes at both ends of the plurality of fuse holes, and wherein the protrusion holes protrude toward each other.
